(19) United States
(12) Patent Application Publication
(10) Pub. No.: US 2026/0030861 A1
(43) Pub. Date: Jan. 29, 2026

(54) SEGMENTATION OF MEDIA CONTENT USING VISION LANGUAGE MODELS

(71) Applicant: NVIDIA Corporation, Santa Clara, CA (US)

(72) Inventors: Yu Wang, Winchester, MA (US); Farzin Aghdasi, East Palo Alto, CA (US); Parthasarathy Sriram, Los Altos Hills, CA (US); Varun Praveen, Cupertino, CA (US)

(21) Appl. No.: 18/787,504

(22) Filed: Jul. 29, 2024

(51) Int. Cl. G06V 10/26; G06F 40/284; G06F 40/30; G06V 10/764; G06V 10/774; G06V 10/82

(52) U.S. Cl. CPC G06V 10/26; G06F 40/284; G06F 40/30; G06V 10/764; G06V 10/774; G06V 10/82

(57) ABSTRACT

Disclosed are apparatuses, systems, and techniques for efficient instance segmentation with vision language models (VLMs). In an embodiment, the techniques include processing an input into the VLM to generate a segmentation map of a media item. The input includes the media item, which includes a plurality of media item units (e.g., pixels, groups of pixels), and further includes a prompt associated with the media item. The segmentation map includes identification of media item units associated with individual objects of one or more objects in the media item, and the VLM includes a dynamic portion having parameters that are determined in view of the media item.

### TECHNICAL FIELD

At least one embodiment pertains to identification of content using artificial intelligence (AI) systems. For example, at least one embodiment pertains to AI systems and techniques for efficient identification of objects or features in a visual content.

### BACKGROUND

Computer vision (CV) automates tasks conventionally performed by human observers. For example, CV models can detect objects or features in images by identifying distinct features in appearances of those individual objects and using the identified features to distinguish objects from the background, from other objects, artifacts, and the like. CV models can process a series of related images (video frames), identify changing locations of various objects, and track motion of those objects. As objects change their size and appearance (and, often, shape) in the course of their motion, the CV models have to ensure that the same objects are consistently tracked across different frames. Vision language models (VLMs) can use understanding of human language and learned associations between visual appearances of objects and their text descriptions to generate natural language descriptions of videos. Such descriptions can include identifications of individual objects, characterization of motion of the objects, nature of the objects, types of interactions between objects, as well as understanding the context and substance of the scene (e.g., traffic accident or hazardous condition occurring, crime being committed), and so on.

### BRIEF DESCRIPTION OF DRAWINGS

FIG. 1 is a block diagram of an example computer architecture capable of performing efficient vision language model-facilitated segmentation of media items, according to at least one embodiment;

FIG. 2 illustrates an example computing device that supports vision language model-facilitated segmentation of media items, according to at least one embodiment;

FIG. 3 illustrates an example data flow of inference segmentation of media items facilitated by a vision language model, according to at least one embodiment;

FIGS. 4A-4C depict schematically an output of a vision language model illustrated in FIG. 3, according to at least one embodiment;

FIG. 5 illustrates an example training of the vision language model depicted in FIG. 3, according to at least one embodiment;

FIG. 6 is a flow diagram of an example method of segmentation of media items facilitated by a vision language model, according to at least one embodiment;

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 is an example data flow diagram for an advanced computing pipeline, according to at least one embodiment; and

FIG. 10 is a system diagram for an example system for training, adapting, instantiating and deploying machine learning models in an advanced computing pipeline, according to at least one embodiment; and

FIG. 11A is a block diagram of an example generative language model system suitable for use in implementing at least some embodiments of the present disclosure;

FIG. 11B is a block diagram of an example embodiment in which the generative LM includes a transformer encoder-decoder, according to at least one embodiment; and

FIG. 11C is a block diagram of an example embodiment in which the generative LM 1130 includes a decoder-only transformer architecture, according to at least one embodiment.

### DETAILED DESCRIPTION

Computer vision processing of images, videos, 2D and 3D objects or features, etc., finds uses in numerous applications that call for analysis of visual data, e.g., identification and tracking of vehicles, people, animals, features, etc., understanding of actions and events, e.g., sporting actions, gaming actions, occurrences of certain anticipated or unexpected acts and/or conditions, e.g., traffic accidents and road conditions, unsafe or undesired manufacturing conditions, and/or the like. An output of a CV model can include localization of objects or features (e.g., using bounding boxes or suitable segmentation techniques), classifications of the objects or features (e.g., among a number of classes learned in training), a degree of confidence in the obtained localizations/classifications, and/or the like. Such outputs can be provided to users and/or used by various downstream systems and applications, e.g., security systems, manufacturing control systems, on-board planners of autonomous vehicles, and/or the like.

VLMs combine CV functionality with that of language models (LMs) for natural language (NL) understanding of data and/or a nature of tasks to be performed on the data. Trained LMs—such as large language models (LLMs)—are capable of supporting conversations in natural language, understanding speaker intents and emotions, explaining complex topics, generating new texts upon receiving suitable prompts, providing recommendations regarding topics of interest to a user, processing image, audio, and/or other data types, and/or performing other functions. For example, an input to a media portion of a VLM can include an image (or a video) of a basketball game and a prompt to a text (LM) portion of a VLM vision language model requesting a particular task to be performed, e.g., “determine a number of players of the red team and the white team in the picture and which team has possession of the ball.” The VLM can then use its cross-modality (image-text) functionality to identify players of each team, e.g., with bounding boxes drawn around individual players and labeled with classifications “red” or “white.” Similarly, the VLM can output a classification for the ball possession (“red” or “white”) and can further draw a bounding box around the ball. VLMs can include closed vocabulary models, trained on specific types of objects, or open vocabulary models that leverage language-comprehension abilities to identify features of previously unseen object(s).

In addition to bounding boxes, outputs of CV models can include segmentation maps (masks) indicative of local (pixel-wise) classifications. For example, semantic segmentation can classify individual pixels of an image as belonging to one of defined classes, e.g., “team A,” “team B,” “ball,” and “background.” Instance segmentation can further identify different instances of each class, e.g., “team A, player 1,” “team A, player 2,” “team A, player 3,” “team B, player 1,” “team B, player 2,” and/or the like. Segmentation outputs often display object boundaries or outlines that are more informative than bounding boxes and are particularly useful for accurate tracking of the objects, including objects that are partially or temporarily occluded. The existing VLMs, however, lack efficient segmentation functionality capable of responding to NL prompts. In particular, the existing techniques are limited to two-stage models, in which the first stage outputs (responsive to natural language prompt instructions) bounding boxes for various objects in images while the second stage performs segmentation of portions cropped using such bounding boxes.

Aspects and embodiments of the present disclosure address these and other challenges of the computer vision technology by providing for single-stage VLM-facilitated segmentation systems and techniques. In some embodiments, VLM-facilitated segmentation may be performed by a model that processes a media input (e.g., an image, a video, an audio, and/or the like) and a text input that includes a prompt with instructions associated with a segmentation task to be performed by the model, e.g., a description of target objects, a description of the scenery (action) depicted in the media input, and/or any other suitable (e.g., contextual) information. The media input may be processed by a media backbone (e.g., a pre-trained CV model), which generates media features (vectors, embeddings, etc.), and the text input may be processed by a text backbone (e.g., a general-purpose pre-trained language comprehension model), which generates text features. The media features and the text features may then be processed by a cross-modality decoder to generate cross-modal features. In some embodiments, prior to inputting into the cross-modality decoder, the media features and the text features may be enhanced by a multi-modal transformer network. In some embodiments, cross-modal features may be processed by one or more convolutional layers to generate segmentation mask features. In some embodiments, the cross-modal features may be aggregated (e.g., concatenated) to media features (or enhanced media features) prior to processing by the convolutional layer(s). The segmentation mask features may be processed by a segmentation (classification) head that generates segmentation masks for the media item. In some embodiments, relative coordinates of various cross-modal features may be included in the segmentation mask features to provide additional spatial context. In some embodiments, the segmentation head can include one or more additional convolutional layers and a suitable classifier (e.g., a sigmoid classifier) generating probabilities that a particular unit (pixel) of the media item is associated with a particular object (instance) of a class. In some embodiments, the convolutional layers of the segmentation head have dynamic parameters (e.g., convolutional kernel parameters) that are themselves determined during processing of the media and text inputs. More specifically, the cross-modal features may be processed by a set of dedicated neuron layers (e.g., convolutional layers) that feed into a controller generating input-specific parameters of the segmentation head. Additional classification heads may process, in parallel, the cross-modality features and output bounding shapes and/or classification of the objects depicted in the media input.

The VLM may deploy pretrained CV and LM as media and text backbones, respectively. Other components of the VLM, e.g., cross-modality decoder, multi-modal transformer, convolutional layers, classification heads, and/or the like, may be trained together, e.g., end-to-end. The training may be performed by combining losses characterizing errors in segmentation masks, localization of objects, and/or classification of objects. In some embodiments, ground truth for segmentation masks may be human-annotated. In other embodiments, the ground truth may be generated using suitable pseudolabeling techniques. For example, a training media item may first be processed by an object detection model that identifies bounding boxes for the objects depicted in the training media item. Cropped portions corresponding to individual bounding boxes may then be processed by a model trained to classify pixels of the cropped portions as foreground or background. The set of foreground pixels is then used as the ground truth segmentation mask for training of the VLM.

The advantages of the disclosed embodiments include, but are not limited to, fast and accurate segmentation using single-stage VLMs that output segmentation masks without initial object detection or concurrently with such object detection. The single-stage architecture of the disclosed model significantly increases the speed of inference and facilitates efficient low-latency streaming segmentation, which can support real-time applications that include automotive applications, sporting or other gaming events, dynamic medical imaging applications, patient safety and wellbeing applications, public and private safety monitoring, industrial safety and control applications, and/or the like.

The systems and methods described herein may be used for a variety of purposes, by way of example and without limitation, for performing one or more operations with respect to machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be implemented in a variety of different systems such as automotive systems (e.g., a control system for an autonomous or semi-autonomous machine, a perception system for an autonomous or semi-autonomous machine, an in-vehicle infotainment system for an autonomous or semi-autonomous machine, etc.), systems implemented using a robot, aerial systems, medical systems, boating systems, smart area monitoring systems, systems for performing deep learning operations, systems for performing simulation operations, systems for performing digital twin operations, systems for performing medical operations, systems for performing factory operations, systems for performing analytics operations, systems for performing medical operations, systems for performing factory operations, systems for performing analytics operations, systems implemented using an edge device, systems for generating or presenting at least one of augmented reality content, virtual reality content, mixed reality content, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implementing one or more language models, such as large language models (LLMs) or vision language models (VLMs) that may process text, voice, image, and/or other data types to generate outputs in one or more formats, systems implemented at least partially using cloud computing resources, systems for performing generative AI operations, and/or other types of systems.

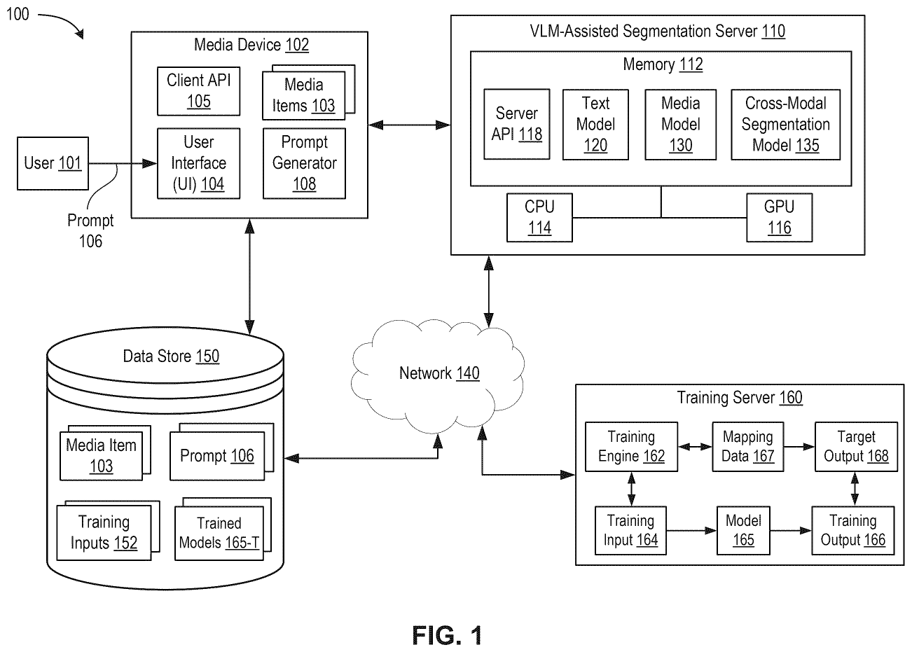

FIG. 1 is a block diagram of an example computer architecture 100 capable of performing efficient vision language model-facilitated segmentation of media items, according to at least one embodiment. As depicted in FIG. 1, computer architecture 100 may include a VLM-assisted segmentation server 110, a media device 102, a data store 150, and a training server 160, which may be connected via a network 140. Network 140 may be a public network (e.g., the Internet), a private network (e.g., a local area network (LAN), or wide area network (WAN)), a wireless network, a personal area network (PAN), a combination thereof, and/or another network type.

Media device 102 may include any camera, video camera, and/or streaming device capable of generating individual images and/or a series of temporally and/or contextually related images. Media device 102 may include any hardware capable of capturing light, including visible light, infrared light, ultraviolet light, and/or other types of electromagnetic waves (e.g., microwaves, radio waves, etc.). The hardware may include digital camera devices, analog camera devices, light detection and ranging (lidar) sensors, radio detection and ranging (radar) sensors, infrared camera sensors, medical imaging sensors, e.g., magnetic resonance imaging (MRI) sensors, computer tomography (CT) imaging sensors, audio sensors (e.g., microphones), and/or the like. Media device 102 may further include any suitable software and/or firmware for processing data collected by the hardware to perform image/video encoding, denoising, filtering, enhancement, authentication, serializing, deserializing, and/or other pre-processing or post-processing operations. Media device 102 may output one or more media items 103, e.g., one or more images, videos (having any suitable frame rate), and/or the like. In some embodiments, media item(s) 103 may include one or more audios (e.g., captured by a live microphone, pre-recorded, streamed from another device, and/or the like), one or more sets of sensor data, and/or the like.

In some embodiments, media device 102 may be connected to a user interface (UI) 104 that may receive (e.g. from a user, an AI system, or any suitable software) one or more prompts 106 associated with media item(s) 103. In some embodiments, UI 104 may include a keyboard or touchpad to capture alphanumeric (e.g., text) inputs of a user, an audio device, e.g., one or more microphones to capture speech inputs by a user, a camera (e.g., a web-camera) to capture a gesture, an image, or a video of a user, and/or the like, or any combination thereof. In some embodiments, text, audio (speech), and/or gesture/image/video input devices may be integrated together (e.g., into a smartphone, tablet computer, desktop computer, headset, and/or the like).

Prompt 106 may include a text (e.g., a sequence of one or more typed words), a speech (e.g., a sequence of one or more spoken words), an image or a video, a gesture(s), and/or some combination thereof. Prompt 106 may be generated as part of interaction of a user with VLM-assisted segmentation server 110. In some embodiments, prompt 106 may be a natural language prompt associated with media item(s) 103. Prompt 106 may be in any suitable language. In some embodiments, UI 104 may translate a received prompt from one language (e.g., Chinese) to some other language (e.g., English) using one or more automated translation resources. Prompt 106 may include a request for a description (e.g., a textual or audio description) of media item(s) 103, a query (question, request, instruction, etc.) about a content of media item(s) 103, which may be a general query about the nature of a scene depicted in media item(s) 103, a question about specific object(s) captured in media item(s) 103, a request to perform analytics for media item(s) 103, and/or the like. In some embodiments, prior to receiving by VLM-assisted segmentation server 110, prompt 106 may be stored in data store 150.

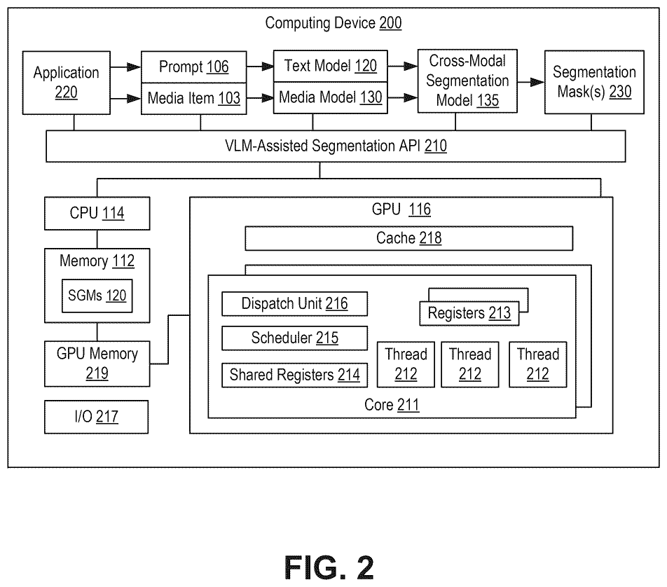

In some embodiments, prompt 106 need not be provided by user 101 and may be generated automatically using prompt generator 108, which may operate as part of any suitable application (e.g., application 220 in FIG. 2) operating on (or in association with) media device 102, VLM-assisted segmentation server 110, and/or other computer device(s). For example, a public safety application may generate prompt 106 with instructions to segment various target objects (e.g., trespassers) in media item(s) 103. An autonomous vehicle application may similarly generate prompt 106 with a description of vehicles to be identified. Such automatic prompts may be processed without an input or a prompt from a user.

Media device 102 may be communicatively coupled with VLM-assisted segmentation server 110. VLM-assisted segmentation server 110 may include a rackmount server, a router computer, a personal computer, a laptop computer, a tablet computer, a desktop computer, a media center, an automotive onboard computer, or any combination thereof. In some embodiments, VLM-assisted segmentation server 110 may include a smartphone, a wearable device, a virtual/augmented/mixed reality headset or head-up display, a digital avatar or chatbot kiosk, an in-vehicle infotainment computing device, and/or any other suitable computing device capable of performing the techniques described herein.

In some embodiments, VLM-assisted segmentation server 110 may deploy techniques of the instant disclosure to perform segmentation of media item(s) 103 generated (or received) by media device 102. In some embodiments, VLM-assisted segmentation server 110 may perform default processing of media item(s) 103 that may be independent of prompt 106, including identifying segmentation masks for any, some, or all objects in media item(s) 103. In other embodiments, processing of media item(s) 103 by VLM-assisted segmentation server 110 may be subject to instructions in prompt 106, e.g., a request to segment one or more target objects of interest. Objects may include any living entities, e.g., people, animals, organisms, plants, etc. Objects may include any non-living entities including natural things (e.g., rivers, mountains, sun, moon, stars, clouds, etc.), human-made things (e.g., manufactured goods), things naturally produced in a way that is modified by technology (e.g., genetically modified entities), and/or the like. Objects may include any symbols and/or abstractions, e.g., characters, numerals, logos, pictures, artistic expressions, and/or the like. VLM-assisted segmentation server 110 may identify segmentation masks using any suitable types of labeling or annotation, e.g. by adding a segmentation identifier (e.g., one or more bits) to individual pixels or any other units (e.g., groups of pixels) of media item(s) 103, highlighting pixels associated with specific objects or replacing such pixels with pixels of a uniform color (which can be different for different objects), storing outlines of the objects, and/or using any other suitable techniques.

In some embodiments, VLM-assisted segmentation server 110 may be located on one or more computing devices/servers, e.g., on a cloud-based server. In some embodiments, VLM-assisted segmentation server 110 may include a memory 112 (e.g., one or more memory devices or units) communicatively coupled to one or more processing devices, such as one or more central processing units (CPU) 114, one or more graphics processing units (GPU) 116, one or more data processing units (DPU), one or more parallel processing units (PPUs), and/or other processing devices (e.g., field-programmable gate arrays (FPGAs), application-specific integrated circuits (ASICs), and/or the like). Memory 112 may include a read-only memory (ROM), a flash memory, a dynamic random-access memory (DRAM), such as synchronous DRAM (SDRAM), a static memory, such as static random-access memory (SRAM), and/or some other memory capable of storing digital data.

Memory 112 may store one or more models trained to process media items 103 and prompts 106, e.g., a text model 120, a media model 130, a cross-modal segmentation model 135, and/or the like.

Text model 120 may be (or include) a LM trained to have language proficiency. Text model 120 may be an LLM having at least 100K of learnable parameters, 500K of learnable parameters, 1 M of learnable parameters, and/or the like. Text model 120 may undergo self-supervised training on large amounts of text data and/or other data types, depending on the embodiment, and learn to predict the next and/or missing tokens (which may correspond to sub-words, symbols, words, etc.) in a phrase/sentence, detect intent and/or sentiment of a human speaker, determine if two sentences are related or unrelated, and/or perform other basic language tasks. Following the initial training, text model 120 may undergo a suitable instructional (prompt-based) supervised fine-tuning that causes text model 120 to acquire more in-depth language proficiency and/or master more specialized tasks (e.g., acquiring expertise in one or more areas of knowledge). Supervised fine-tuning includes using learning prompts (questions, hints, etc.) that are accompanied by example texts (e.g., answers, sample essays, etc.) serving as training ground truth. In some embodiments, text model 120 may further undergo reinforcement fine-tuning, in which a human evaluator assigns grades indicative of a degree to which the generated texts resemble human-produced texts. Trained text model 120 may process prompt 106 and generate one or more text features capturing content and context of prompt 106.

Media model 130 may be (or include) a model that is pre-trained to perform one or more computer vision tasks, e.g., representing objects via feature vectors (embeddings), detecting presence of objects, localizing objects, identifying a type of objects, and/or the like. In some embodiments, media model 130 may process inputs of any suitable modality, e.g., images, videos, 3D data (such as universal scene descriptor (USD) data), computer aided design (CAD) data, and/or the like. In some embodiments, media model 130 may process audio data. Media model 130 may process media item(s) 103 and generate one or more media features capturing visual content of media item(s) 103.

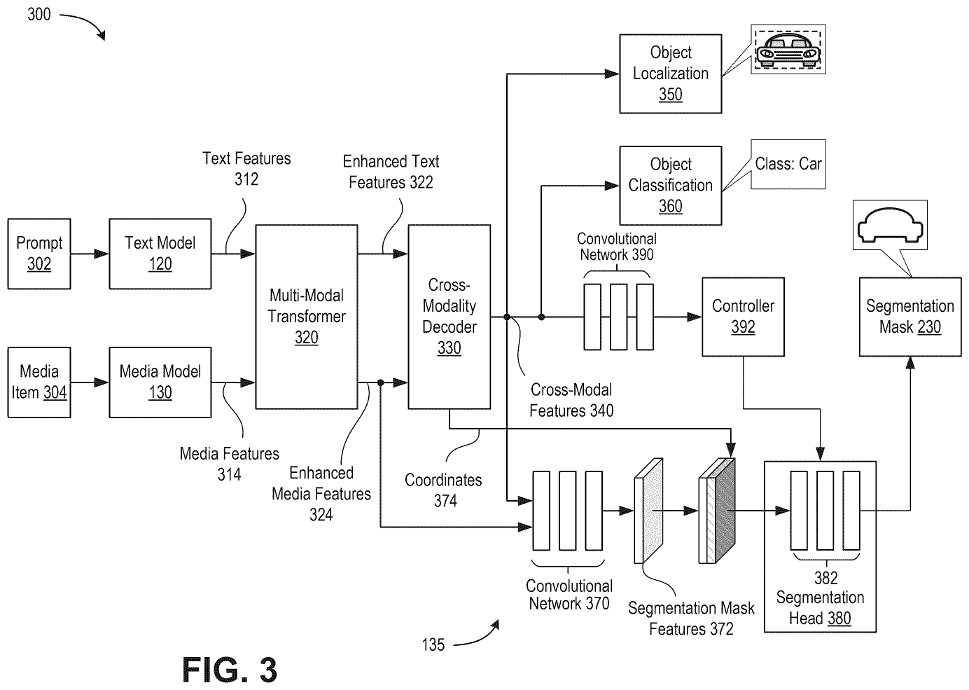

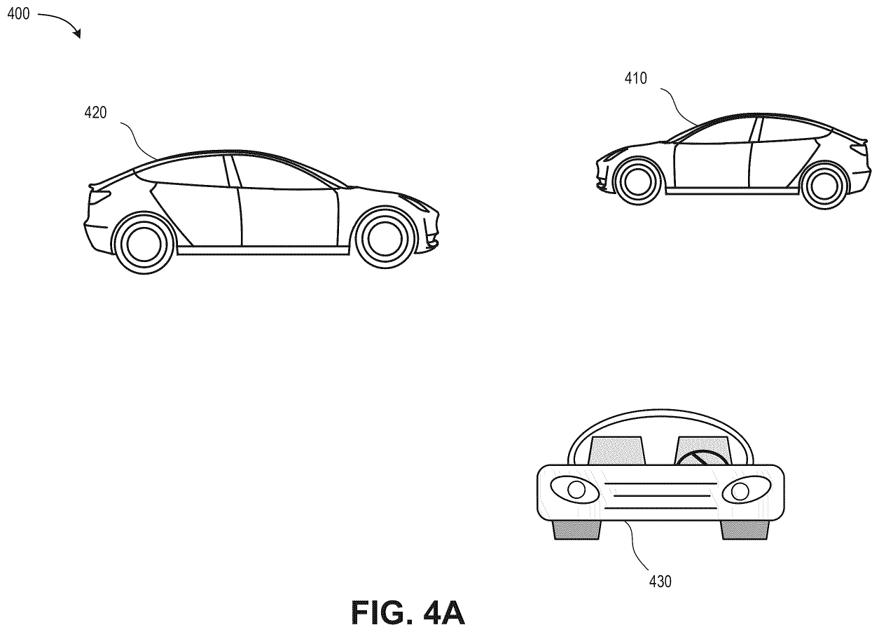

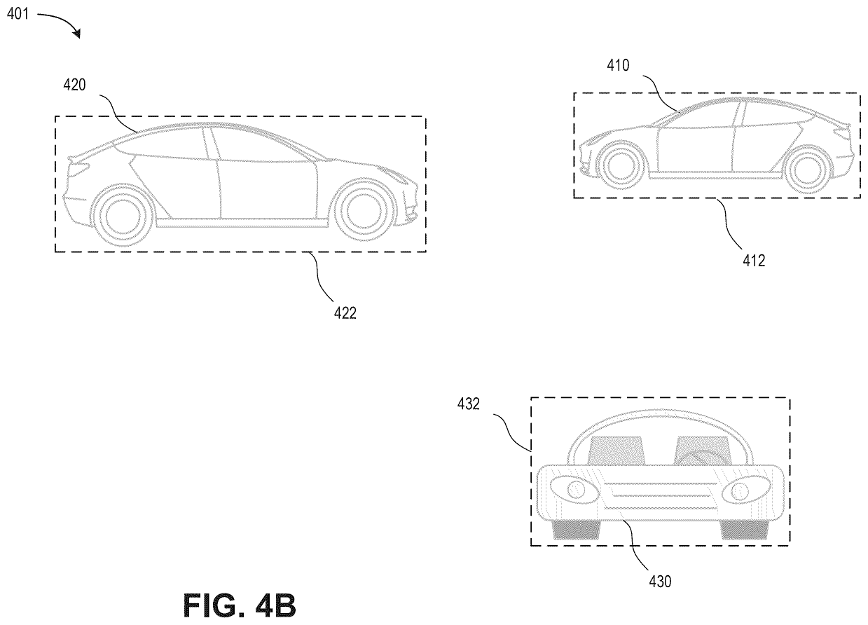

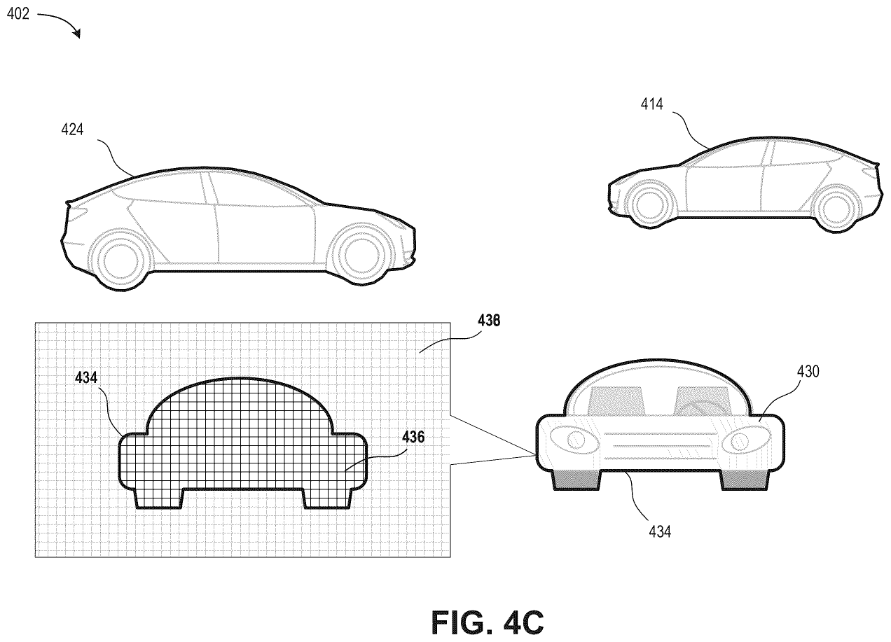

Cross-modal segmentation model 135 may be trained to process the text features and media features to generate segmentation masks, e.g., as disclosed in more detail below in conjunction with FIG. 3 and FIG. 4.

In some embodiments, memory 112 may store a server Application Programming Interface (API) that facilitates deployment and application of text model 120, media model 130, cross-modal segmentation model 135, and/or other components not explicitly shown in FIG. 1. In some embodiments, media device 102 may download a client API 105 from VLM-assisted segmentation server 110 and deploy client API 105 to facilitate communications with server API 118.

In some embodiments, any, some, or all of text model 120, media model 130, and/or cross-modal segmentation model 135 may be implemented as deep learning neural networks having multiple layers of linear or non-linear operations, e.g., a convolutional neural network, a recurrent neural network, a fully-connected neural network, a long short-term memory (LSTM) neural network, a neural network with attention, e.g., a transformer neural network, and/or the like, and/or any combination thereof. In at least one embodiment, any, some, or all of text model 120, media model 130, cross-modal segmentation model 135 may include multiple neurons, an individual neuron receiving its input from other neurons and/or from an external source and producing an output by applying an activation function to a combination of inputs modified by (trainable) weights and a bias value. Neurons may be arranged in layers, including an input layer, one or more hidden layers, and/or an output layer. Neurons from adjacent layers may be connected by weighted edges. In some embodiments, any, some, or all of text model 120, media model 130, cross-modal segmentation model 135 may have different architecture, number of neuron layers, number of neurons in various layers, and/or the like.

Text model 120, media model 130, and/or cross-modal segmentation model 135 may be trained using training engine 162 hosted by training server 160, which may be (or include) a desktop computer, a laptop computer, a smartphone, a tablet computer, a server, and/or any suitable computing device capable of performing the techniques described herein. Training of the models may be performed using training data that includes videos annotated with ground truth, e.g., correct identifications of various target objects. Training of some of the models may further include zero-shot training where the models are given training prompts to identify objects that have not been encountered in previous training epochs. In some embodiments, visual and/or textual data used for training may be generated using a simulated environment (e.g., NVIDIA's DriveSIM or OMNIVERSE, the METAVERSE, and/or the like) and/or synthetically generated data. Where a simulated environment and/or synthetically generated data is used, ray-tracing or other light transport simulation algorithms may be deployed to increase the realism of the training data generated, and to more accurately represent lighting, shadows, shading, reflections, etc.

During training, predictions of a particular model 165 being trained (e.g., text model 120, media model 130, cross-modal segmentation model 135, etc.) may be compared with ground truth annotations. More specifically, training engine 162 may cause a model to process training inputs 164 (including training videos 152, which may be accompanied by training prompts) stored in data store 150 and generate training outputs 166, which represent annotations (identifications) of objects in the corresponding training inputs 164. During training, training engine 162 may also generate mapping data 167 (e.g., metadata) that associates training inputs 164 with correct target outputs 168. Target outputs 168 may include ground truth annotations (identifications) for corresponding training inputs 164. Training causes the model(s) 165 to identify patterns in training inputs 164 based on desired target outputs 168 and learn to accurately classify input data.

Initially, edge parameters (e.g., weights and biases) of the model(s) 165 being trained may be assigned some starting (e.g., random) values. For every training input 164, training engine 162 may compare a training output 166 with the corresponding target output 168. The resulting error or mismatch, e.g., the difference between the desired target output 168 and the generated training output 166 may be back-propagated through the model(s) 165 and at least some parameters of model(s) 165 may be changed in a way that brings the training output 166 closer to the target output 168. Such adjustments may be repeated until the output error for a given training input 164 satisfies a predetermined condition (e.g., falls below a predetermined value). Subsequently, a different training input 164/target output 168 may be selected, a new training output 166 generated, and a new series of adjustments implemented, until the model is trained to a target degree of accuracy or until the model converges to a limit of its (architecture-determined) performance.

Training server 160 may train any number of models 165 (e.g., text model 120, media model 130, cross-modal segmentation model 135, etc.) using suitable sets of training inputs 164 and target outputs 168. Trained models 165-T may be stored in data store 150 and downloaded and deployed on any suitable machine for the inference of new data. For example, trained models 165-T deployed on VLM-assisted segmentation server 110 may include any, some, or all of text model 120, media model 130, and/or cross-modal segmentation model 135. Similarly, trained models 165-T may be deployed on any other device, including any computing device that uses computer vision techniques, e.g., a media-processing device, an on-board computer of an autonomous vehicle, a public or private surveillance system, a traffic control system, an industrial control system, and/or the like.

FIG. 2 illustrates an example computing device 200 that supports vision language model-facilitated segmentation of media items, according to at least one embodiment. In at least one embodiment, computing device 200 may be a part of VLM-assisted segmentation server 110 and/or a part of media device 102 (with reference to FIG. 1). In at least one embodiment, computing device 200 may deploy VLM-assisted segmentation API 210, which may include server API 118 and/or client API 105 (with reference to FIG. 1) that support(s) operations of a segmentation pipeline. As illustrated in FIG. 2, the segmentation pipeline may include receiving, e.g., from (or via) any suitable application 220, a prompt 106 and a media item 103 associated with prompt 106. The segmentation pipeline may further include processing prompt 106 using text model 120 and processing media item 103 using media model 130. The outputs of text model 120 and media model 130 may then be processed by cross-modal segmentation model 135 that generates segmentation masks 230 for media item 103.

Operations of text model 120, media model 130, cross-modal segmentation model 135, various modules operating in conjunction with the segmentation pipeline, and/or other software/firmware instantiated on computing device 200 may be executed using one or more CPUs 114, one or more GPUs 116, one or more parallel processing units (PPUs) or accelerators, such as a deep learning accelerator, data processing units (DPUs), and/or the like. In at least one embodiment, a GPU 116 includes multiple cores 211. An individual core 211 may be capable of executing multiple threads 212. Individual cores 211 may run multiple threads 212 concurrently (e.g., in parallel). In at least one embodiment, threads 212 may have access to registers 213. Registers 213 may be thread-specific registers with access to a register restricted to a respective thread. Additionally, shared registers 214 may be accessed by one or more (e.g., all) threads of a core 211. In at least one embodiment, individual cores 211 may include a scheduler 215 to distribute computational tasks and processes among different threads 212 of the core. A dispatch unit 216 may implement scheduled tasks on appropriate threads using correct private registers 213 and shared registers 214. Computing device 200 may include input/output component(s) 217 to facilitate exchange of information with one or more users or developers.

In at least one embodiment, GPU 116 may have a (high-speed) cache 218, access to which may be shared by multiple cores 211. Furthermore, computing device 200 may include a GPU memory 219 where GPU 116 may store intermediate and/or final results (outputs) of various computations performed by GPU 116. After completion of a particular task, GPU 116 (or CPU 114) may move the output to (main) memory 112. In at least one embodiment, CPU 114 may execute processes that involve serial computational tasks whereas GPU 116 may execute tasks (such as multiplication of inputs of a neural node by weights and adding biases) that are amenable to parallel processing.

FIG. 3 illustrates an example data flow 300 of inference segmentation of media items facilitated by a vision language model, according to at least one embodiment. Segmentation operations illustrated in FIG. 3 may be performed using one or more computing devices of VLM-assisted segmentation server 110 (with reference to FIG. 1). In some embodiments, any, some, or all operations illustrated in FIG. 3 may be performed locally on media device 102. In some embodiments, the segmentation operations include receiving a prompt 302 and media item 304. Prompt 302 may be received from a user, e.g., as part of a live conversation, generated using any suitable computer application (e.g., software), and/or may be generated (and stored) previously and subsequently retrieved from a memory device (e.g., memory 112 of VLM-assisted segmentation server 110 and/or memory of media device 102). Prompt 302 may include image(s), video(s) (e.g., temporally, visually, and contextually related sequences of images/frames), audio(s), and or any other data items produced by suitable sensor(s), which may include camera(s), video camera(s), infrared camera(s), microphone(s), sonar(s), lidar(s), radar(s), and/or any other physical or chemical sensors, e.g., temperature sensors, pressure sensors, humidity sensors, smoke-detection sensors, chemical composition sensors, motion-detection sensors, accelerometers, altitude sensors, global positioning sensors, and/or the like. Media item 304 may be associated with prompt 302. Media item 304 may be (or include) any still image or any time series of images (or other data), e.g., a sequence of video frames. For example, media item 304 may be explicitly referenced in prompt 302 (e.g., by specifying a storage location of media item 304), directly attached (e.g., as a data file) to prompt 302, implicitly associated with prompt 302, and/or associated in any other way that unambiguously identifies media item 304.

Prompt 302 may be a natural language prompt, e.g., a request for any applicable description of media item 304, which may be (or include) a quantitative description (such as a request for a number of objects of specific type in media item 304), a qualitative or conceptual description of a content of media item 304 (e.g., “which tennis player has scored the last point?”). Prompt 302 may be formulated as (or include) a question (e.g., as in the last example), an instruction (e.g., “count the number of players in the white-and-blue uniform on ice prior to the play stoppage”), a task (e.g., determine if the white-and-blue team had too many players on ice before the play stoppage “), and/or another inquiry in any other suitable form. In some embodiments, prompt 302 may be a textual representation of an audio data or visual data received from a user or retrieved from memory.

In some embodiments, prompt 302 may be tokenized using a suitable tokenizer. Tokens may encode units of speech (e.g., words, syllables, etc.) as numbers. In one example of GPT-4 tokens, word “the” may be represented via token “280”, word “import” may be represented via token “476,” word “description” may be represented via token “4097,” and so on. In some embodiments, individual words may be represented via any number of tokens or word transitions. For example, a long word or a word that contains multiple words may be represented via multiple tokens, e.g., with one token used to represent a beginning portion of the word and another token(s) representing a middle or end portion of the word. In some instances, even a long/composite word may be represented by a single token. The tokenization may be performed in any manner that is suitable for inputting into a language-comprehension model.

Prompt 302 may be processed by a language-comprehension backbone model, e.g., text model 120, to generate text features 312 (feature vectors, embeddings, etc.). Text model 120 may be trained to identify contextual and semantic connections between various units (e.g., words, phrases, etc.) of prompt 302 (and/or other text inputs). Media item 304 may be processed by a media-processing backbone, e.g., media model 130, to generate media features 314. Media model 130 may be trained to identify visual patterns in images of various objects. Any or both text model 120 and media model 130 may include one or more self-attention blocks to identify associations between different units of the respective inputs (e.g., text inputs and media inputs, respectively).

Text features 312 and media features 314 may be processed by a multi-modal transformer 320 that uses one or more cross-attention blocks (but may also include any number of self-attention blocks) to identify associations between units of prompt 302 and units of content of media item 304. For example, a first block of multi-modal transformer 320 may be a text-to-media cross-attention block that uses text features 312 as queries and media features 314 as keys and values (or vice versa) while a second block of multi-modal transformer 320 may be a media-to-text cross-attention block that uses the media features (e.g., suitably processed by the first portion) as queries and the text media features as keys and values. In some embodiments, the first cross-attention block may be a media-to-text cross-attention block and the second cross-attention block may be a text-to-media cross-attention block. Multi-modal transformer 320 may also include any number of additional stacked text-to-media cross-attention blocks and media-to-text cross-attention blocks, deployed one after another. The number of such stacked cross-attention blocks need not be limited. Additionally, multi-model transformer 320 may include any number of self-attention blocks that process the text features and the media features individually and/or any number of fully-connected layers, residual (skipped) connections, normalization layers, and/or the like.

Multi-modal transformer 320 may convert text features 312 and media features 314 into enhanced text features 322 and enhanced media features 324, respectively. These enhanced features retain the information contained in the individual input modalities (text features 312 and media features 314) while also capturing important contextual knowledge of the other input modalities.

The enhanced text features 322 and enhanced media features 324 may then be processed by a cross-modality decoder 330. In some embodiments, cross-modality decoder 330 may select a predetermined number K of enhanced media features 324 having the most similarity (e.g., cosine similarity) to the enhanced text features 322. These K enhanced media features 324 may be used as cross-modal queries (which may have randomly-initiated components) by the cross-modality decoder 330 that may further use enhanced text features 322 and enhanced media features 324 as keys/values in cross-attention processing. Additionally, the cross-modal queries may be processed by one or more self-attention blocks (e.g., positioned prior to or after the cross-attention blocks), fully-connection layers, normalization layers, and/or the like.

The cross-modality decoder 330 outputs updated cross-modal queries, which are also referred to as cross-modal features 340 herein. Cross-modal features 340 may be used as an input into one or more classification networks. For example, an object localization head 350 may process cross-modal features 340 to output bounding boxes, convex hulls, or some other bounding shapes that enclose individual objects in media item 304. An object classification head 360 may process cross-modal features 340 to output classifications of such individual objects (e.g., class “car,” class “pedestrian,” class “road sign,” etc.). In some embodiments, object localization head 350 and/or object classification head 360 may include one or more fully-connected layers.

An additional segmentation mask 230 may be generated by cross-modal segmentation model 135 that may include one or more components, as disclosed in more detail below. More specifically, cross-modal features 340 may be processed using a convolutional network 370, having one or more convolutional layers, to generate segmentation mask features 372. In some embodiments, prior to processing by convolutional network 370, the cross-modal features 340 may be aggregated with (e.g., concatenated or otherwise appended to) enhanced media features 324. Segmentation mask features 372 may be processed by a segmentation head 380 that generates segmentation mask 230 for media item 304. In some embodiments, relative coordinates 374 of various cross-modal features 340 (e.g., as generated by cross-modality decoder 330) may be appended to segmentation mask features 372 to provide additional spatial context to the processing by segmentation head 380.

Segmentation head 380 may include one or more convolutional layers 382 and a suitable classifier (e.g., a sigmoid classifier, not shown in FIG. 3) generating probabilities that a particular unit (pixel) of media item 304 is associated with an individual object. In some embodiments, convolutional layers 382 of segmentation head 380 have dynamic parameters (e.g., convolutional kernel parameters) that are determined as part of processing of media item 304 and prompt 302. For example, cross-modal features 340 may be additionally processed by a separate convolutional network 390. Features output by convolutional network 390 may then be used by a trained controller 392 to generates input-specific parameters of the convolutional layers 382 of segmentation head 380. Controller 392 may include one or more fully-convolutional layers with the number of output channels equal to the number of parameters of segmentation head 380.

In one example, segmentation head 380 may have a fully-convolutional architecture, e.g., having three (or some other number of) 1×1 convolutional layers 382. Individual layers may have 8 channels. Convolutional layers 382 may have any suitable activation function, e.g., ReLU function, with the exception of the last layer, which may deploy the sigmoid as the activation function.

FIGS. 4A-4C depict schematically an output of a vision language model illustrated in FIG. 3, according to at least one embodiment. FIG. 4A illustrates an image 400 of objects 410, 420, and 430 (e.g., vehicles). Image 400 may be used as a media input into the VLM. Image 400 may be processed together with a suitable prompt, e.g., a request to the VLM to identify all vehicles in image 400. FIG. 4B depicts schematically an object localization output 401 generated by object localization head 350 (with reference to FIG. 3) for image 400. Object localization output 401 may include bounding boxes 412, 422, and 432 for the objects 410, 420, and 430, respectively. The bounding boxes and/or may be identified by specifying coordinates of two or more vertices (corners) of the bounding boxes, e.g., coordinates x_{BL}, y_{BL} of the bottom left (BL) corner and coordinates x_{TR}, y_{TR} the top right (TR) corner of a bounding box or some other suitable coordinates (e.g., coordinate of the center of the bounding box together with dimensions of the bounding box). In some embodiments, instead of generating bounding boxes, object localization head 350 may output convex hulls or other more complex bounding shapes. In some embodiments, bounding boxes generated by object localization head 350 may be three-dimensional shapes defined by six coordinates (e.g., coordinates of two vertices connected by a spatial diagonal of the box or three coordinates of the center of the box plus three dimensions of the box, e.g., the length, the width, and the height). FIG. 4C depicts schematically an instance segmentation output 402 generated by segmentation head 230 (with reference to FIG. 3) for image 400. Instance segmentation output 402 may include instance segmentation masks 414, 424, and 434 for the objects 410, 420, and 430, respectively. As illustrated with the callout block in FIG. 4C, segmentation mask 434 may include (binary) classifications of pixels of a region encompassing object 430. Darker pixels 436 are classified (e.g., binary classifier output C=1) as belonging to segmentation mask 434 of object 430. Lighter pixels 438 are classified (e.g., binary classifier output C=0) as belonging to the background of object 430.

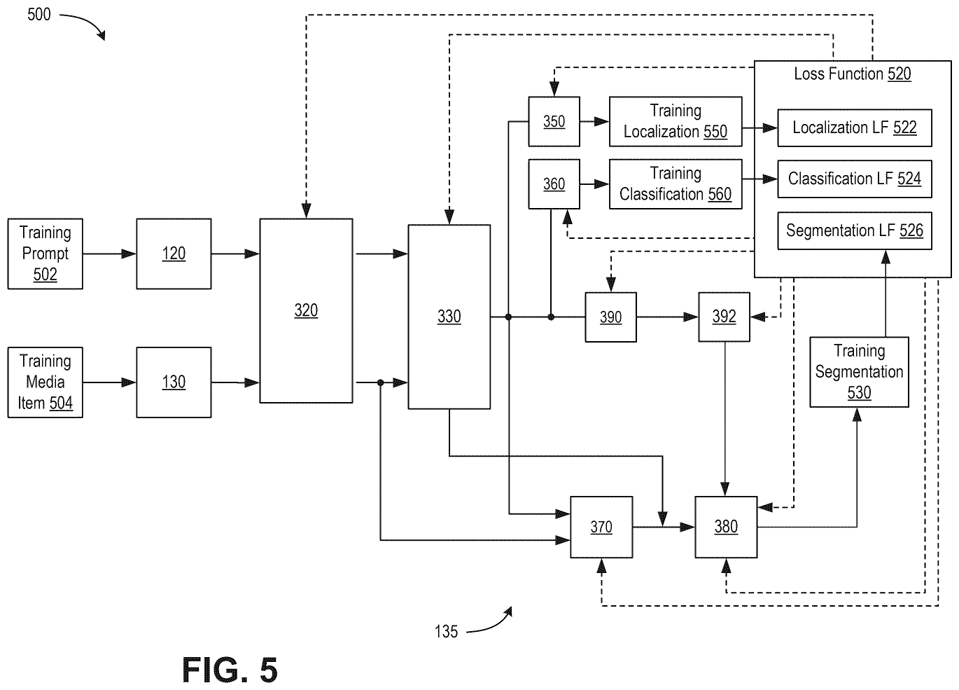

FIG. 5 illustrates an example training 500 of the vision language model depicted in FIG. 3, according to at least one embodiment. In at least one embodiment, various components of the VLM (e.g., text model 120, media model 130, cross-modal segmentation model 135, and/or the like) may be trained by training engine 162 of training server 160 and subsequently uploaded to VLM-assisted segmentation server 110 (with reference to FIG. 1). Various blocks denoted in FIG. 5 with the same numerals as the respective blocks of FIG. 3 may implement the same (or a similar) functionality.

Training prompt 502 may be processed by text model 120. Training prompt 502 may first be pre-processed by a suitable tokenizer, which may be the same tokenizer as is used to tokenize (inference) prompt 302 (with reference to FIG. 3). Training media item 504 may be processed by media model 130. Features produced by text model 120 and media model 130 may be processed by multi-modal transformer 320 and cross-modality decoder 330 to generate cross-modal features, which may be used, e.g., substantially as disclosed in conjunction with FIG. 3, to obtain training outputs for the training media item 504. The training outputs may include training localization 550, e.g., one or more bounding shapes for objects captured in media item 504, training classification 560, e.g., one or more classes (types) for the objects captured in media item 504, and training segmentation 530, e.g., one or more segmentation masks for the objects captured in media item 504.

Training outputs may be compared with ground truth using a suitable loss function (LF) 520 or a set of multiple LFs. More specifically, training localization 550 may be compared, e.g., using localization LF 522, to a localization ground truth. The localization ground truth may include bounding boxes (or other bounding shapes) that are manually annotated by a developer or auto-labeled by a trained object detection model.

Training classification 560 may be compared, e.g., using classification LF 524, to a classification ground truth. The classification ground truth may include classes of objects that are manually annotated by a developer or auto-labeled by a trained object classification model.

Training segmentation 530 may be compared, e.g., using segmentation LF 526, with a segmentation ground truth. The segmentation ground truth may include segmentation masks of objects that are manually created (e.g., drawn) by a developer or auto-labeled by a trained segmentation model. In some embodiments, segmentation ground truth may be generated using pseudolabeling. For example, the localization ground truth, e.g., bounding shapes obtained (e.g., as described above) for the training media item 504 using a dedicated object detection model may subsequently be processed by a model that classifies pixels of the bounding shapes as either foreground pixels or background pixels. The set of foreground pixels may then be used as the segmentation ground truth for the training media item 504.

Any of the localization LF 522, classification LF 524, and/or segmentation LF 526 may be (or include) a cross-entropy loss function, a mean square error loss function, mean absolute error loss function, hinge loss function, Huber loss function, log-cosh loss function, and/or the like. The difference (mismatch) between the training outputs and the ground truth, quantified by the loss function 520, may be used to modify (as depicted schematically with dashed arrows in FIG. 5), e.g., using various techniques of backpropagation, gradient descent, and/or other training techniques, parameters of various networks of the VLM, e.g., multi-modal transformer 320, cross-modality decoder 330, object localization head 350, object classification head 360, convolutional networks 370 and 390, segmentation head 380, controller 392, and/or other components of the VLM.

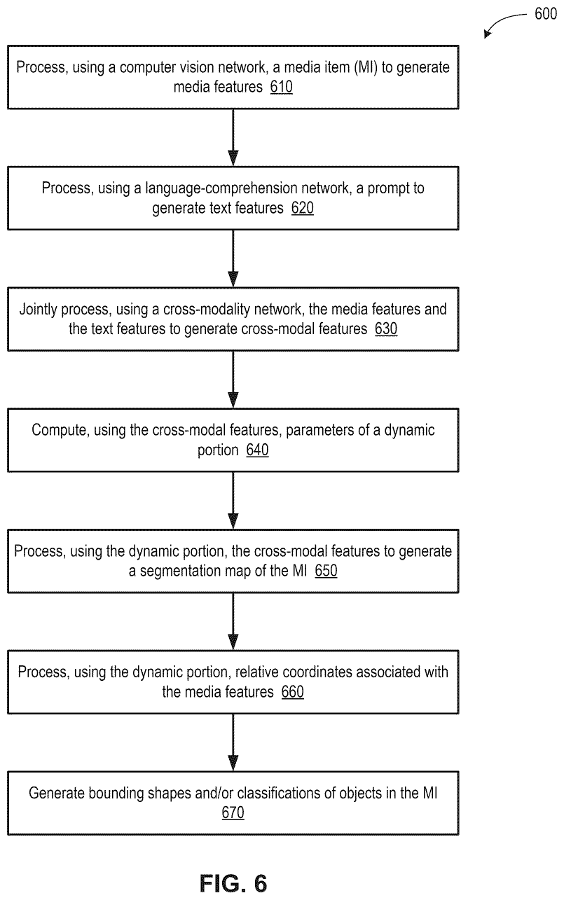

FIG. 6 is a flow diagram of an example method 600 of segmentation of media items facilitated by a vision language model, according to at least one embodiment. In at least one embodiment, method 600 may be performed using processing units of computing device 200 of FIG. 2, which may be (or include) a device associated with VLM-assisted segmentation server 110, media device 102, and/or other devices. In at least one embodiment, processing units performing method 600 may be executing instructions stored on a non-transient computer-readable storage media. In at least one embodiment, method 600 may be performed using multiple processing threads (e.g., CPU threads and/or GPU threads), with individual threads executing one or more individual functions, routines, subroutines, or operations of the methods. In at least one embodiment, processing threads implementing method 600 may be synchronized (e.g., using semaphores, critical sections, and/or other thread synchronization mechanisms). Alternatively, processing threads implementing method 600 may be executed asynchronously with respect to each other. Various operations of method 600 may be performed in a different order compared with the order shown in FIG. 6. Some operations of method 600 may be performed concurrently with other operations. In at least one embodiment, one or more operations shown in FIG. 6 may not be performed. Method 600 may be performed using inputs that include a prompt and a media item. In some embodiments, the prompt may include a natural language prompt and the media item may include an image item, a video item, an audio item, sensor data item, and/or the like. In some embodiments, the first prompt may be a textual representation of an audio data or visual data from a user or retrieved from memory. For example, a user or a computer software may enter or otherwise generate (including automatically, responsive to a script executed by the software) any suitable query, request, or instruction associated with the media item.

Method 600 may include processing, using a vision language model (VLM), an input that includes a media item (e.g., media item 304 in FIG. 3) having a plurality of media item units (e.g., pixels, groups of pixels). The input may further include the prompt (e.g., prompt 302) associated with the media item. The VLM may generate a segmentation map of the media item. In some embodiments, the generated segmentation map (e.g., as illustrated in FIG. 4C) may include identification of media item units associated with individual objects of one or more objects in the media item. In some embodiments, the VLM may include a dynamic portion (e.g., segmentation head 380 in FIG. 3) having parameters that are determined in view of the media item.

In some embodiments, method 600 may include, at block 610, processing, using a computer vision network (e.g., media model 130 in FIG. 3), the media item to generate a plurality of media features (e.g., media features 314). In some embodiments, the plurality of media features may be enhanced using an attention-based network (e.g., multi-modal transformer 320). The attention-based network may use the plurality of media features as queries and the plurality of text features as keys and values and/or may use the plurality of text features as queries and the plurality of media features as keys and values, or both.

At block 620, processing the input may further include processing, using a language-comprehension network (e.g., text model 120 in FIG. 3), the prompt to generate a plurality of text features (e.g., text features 312). In some embodiments, the plurality of text features may also be enhanced using the same attention-based network as is used to enhance the media features. The plurality of media features and the plurality of text features may be used to generate the segmentation map of the media item.

In some embodiments, generating the plurality of media features and the plurality of text features may involve operations of blocks 630-660. In particular, at block 630, method 600 may include jointly processing, using a cross-modality network (e.g., cross-modality decoder 330) the plurality of media features and the plurality of text features to generate a plurality of cross-modal features (e.g., cross-modal features 340).

The plurality of cross-modal features may be used to generate the segmentation map of the media item. More specifically, at block 640, method 600 may include computing, using the plurality of cross-modal features, parameters of the dynamic portion. For example, the parameters of the dynamic portion (e.g., segmentation head 380) may be generated by convolutional network 390 and controller 392 (with reference to FIG. 3). At block 650, method 600 may continue with processing, using the dynamic portion, at least the plurality of cross-modal features to generate the segmentation map of the media item. As illustrated with block 660, method 600 may further include using the dynamic portion to process a plurality of coordinates (e.g., relative coordinates 374) associated with the media features. For example, the coordinates may be concatenated with the cross-modal features to form an input into the dynamic portion.

At block 670, method 600 may further include generating, using the VLM, bounding shapes for the one or more objects in the media item (e.g., using object localization head 350), classification of the one or more objects in the media item (e.g., using object classification head 360), or both.

In some embodiments, operations of method 600 may include causing performance of one or more actions by at least one downstream system or application based on the identification of the pixels in the segmentation map. For example, the one or more performed actions may include generating a description (e.g., a commentary) of the MI, tracking one or more objects depicted in the MI (including determining coordinates, speed, acceleration, and other dynamic characteristics of the objects), identifying a type of a scene depicted in the MI (e.g., an accident, a normal traffic flow, a traffic congestion), identifying a type of an action depicted in the MI (e.g., a team scoring in a game, a game stoppage, etc.), controlling an autonomous vehicle (e.g., braking, steering, accelerating the vehicle), modifying operations of a manufacturing control system (e.g., stopping or modifying one or more parameters of a manufacturing line or process), controlling a security system (e.g., making a decision that the one or more objects represent a security concern), generating an automated medical diagnostic determination (e.g., identifying one or more patient conditions/diseases based on a medical imaging MI), generating an automated patient wellbeing alarm (e.g., observing that a patient is in a dangerous state or condition at home, assisted living facility, medical inpatient facility, medical outpatient facility, etc.), and/or the like.

In some embodiments, the VLM whose operations are illustrated in FIG. 3 may be trained using training data that includes a training input containing a training media item, a training prompt associated with the training media item, and a ground truth segmentation mask associated with the training media item. In some embodiments, the ground truth segmentation mask may be generated by a machine learning model processing an input that includes a cropped portion depicting an object in the training media and identifying a foreground of the cropped portion.

### Inference and Training Logic

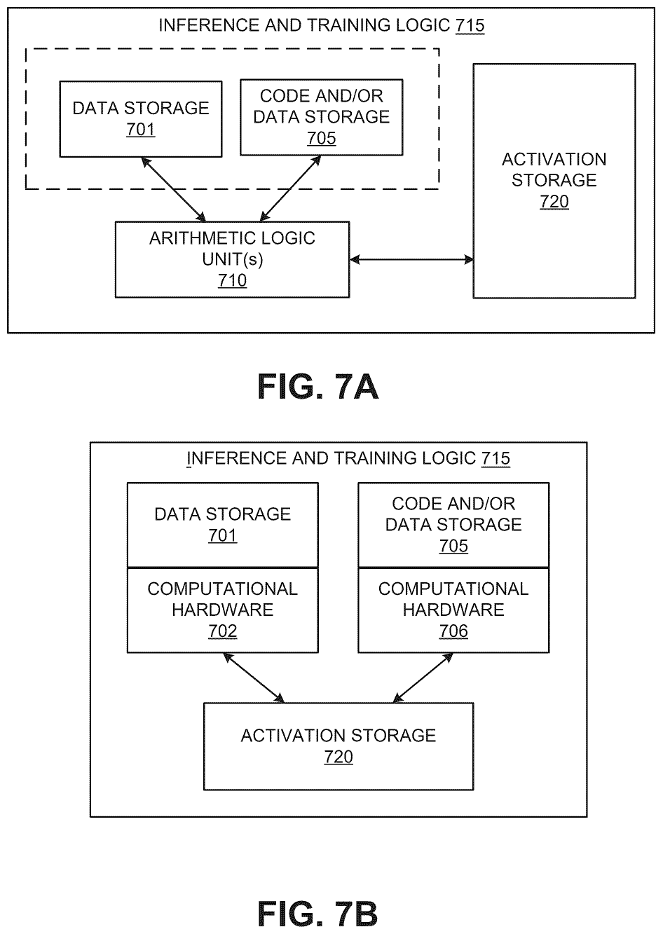

FIG. 7A illustrates inference and/or training logic 715 used to perform inferencing and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

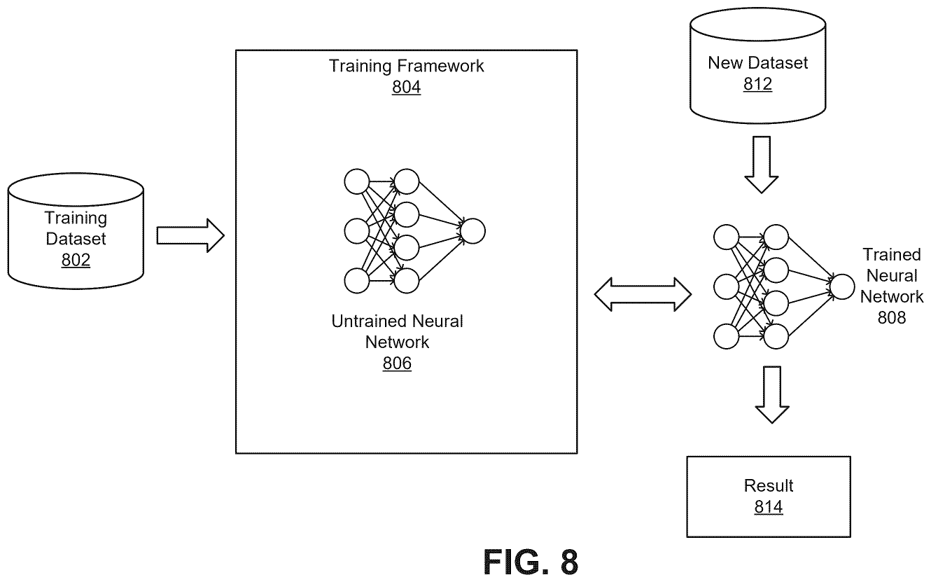

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, whereas untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

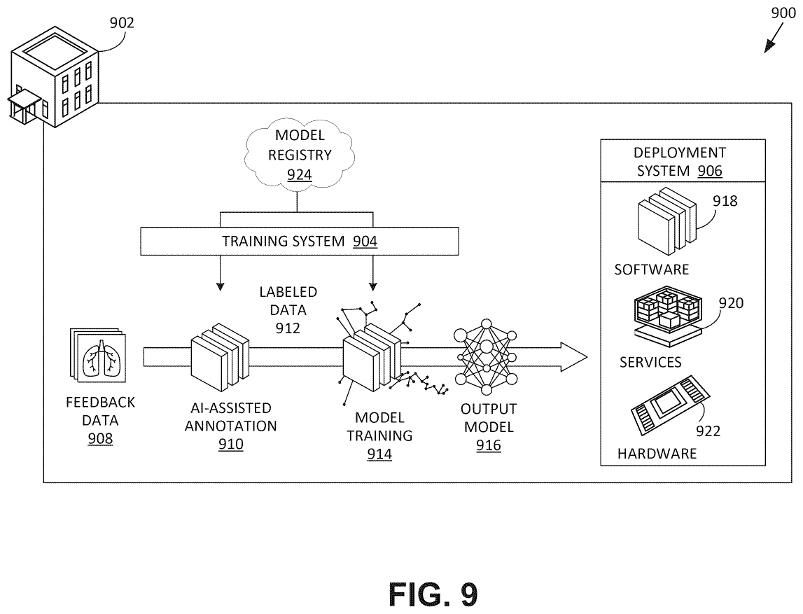

With reference to FIG. 9, FIG. 9 is an example data flow diagram for a process 900 of generating and deploying a processing and inferencing pipeline, according to at least one embodiment. In at least one embodiment, process 900 may be deployed to perform game name recognition analysis and inferencing on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in advanced processing and inferencing pipelines may use machine learning models or other AI to perform one or more processing steps. In at least one embodiment, machine learning models may be trained at facility 902 using feedback data 908 (such as imaging data) stored at facility 902 or feedback data 908 from another facility or facilities, or a combination thereof. In at least one embodiment, training system 904 may be used to provide applications, services, and/or other resources for generating working, deployable machine learning models for deployment system 906.

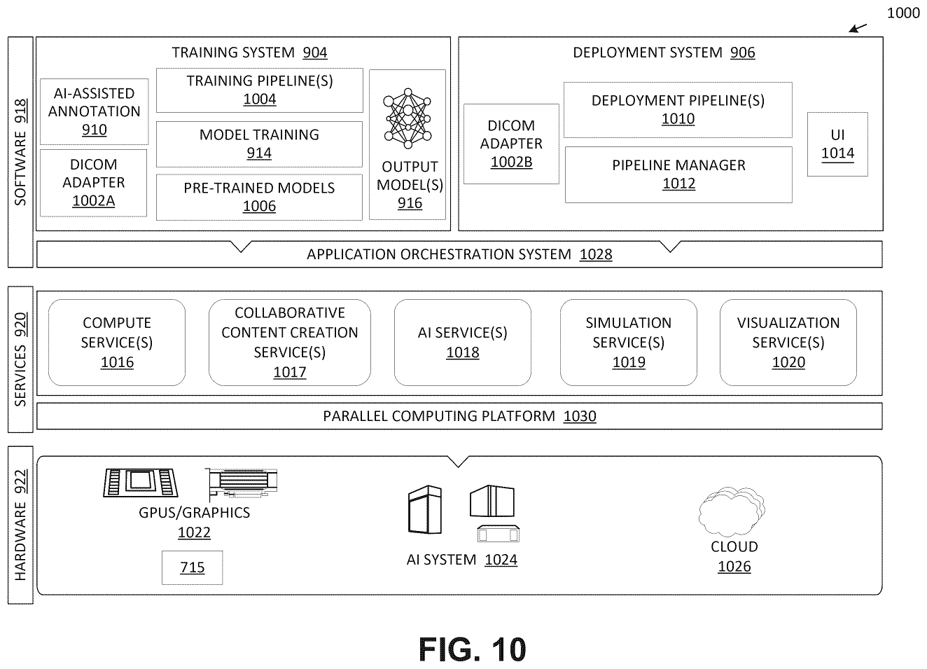

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model, or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIGS. 9-10. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities that are remotely located). In at least one embodiment, machine learning models may have been trained on imaging data from one location, two locations, or any number of locations. In at least one embodiment, when being trained on imaging data, which may be a form of feedback data 908, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914—e.g., AI-assisted annotations 910, labeled data 912, or a combination thereof—may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inferencing pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., system 1000 of FIG. 10). In at least one embodiment, once validated by system 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, collaborative content creation services, simulation services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 918 implementing advanced processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, simulation, and visual computing, as non-limiting examples. In at least one embodiment, at least some of the computing environment of deployment system 906 and/or training system 904 may be executed in a datacenter or one or more supercomputers or high performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example system 1000 for generating and deploying a deployment pipeline, according to at least one embodiment. In at least one embodiment, system 1000 may be used to implement process 900 of FIG. 9 and/or other processes including advanced processing and inferencing pipelines. In at least one embodiment, system 1000 may include training system 904 and deployment system 906. In at least one embodiment, training system 904 and deployment system 906 may be implemented using software 918, services 920, and/or hardware 922, as described herein.

In at least one embodiment, system 1000 (e.g., training system 904 and/or deployment system 906) may implemented in a cloud computing environment (e.g., using cloud 1026). In at least one embodiment, system 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1000, may be restricted to a set of public internet service providers (ISPs) that have been vetted or authorized for interaction.

In at least one embodiment, various components of system 1000 may communicate between and among one another using any of a variety of different network types, including but not limited to local area networks (LANs) and/or wide area networks (WANs) via wired and/or wireless communication protocols. In at least one embodiment, communication between facilities and components of system 1000 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904, and may be implemented by deployment system 906.

In at least one embodiment, output model(s) 916 and/or pre-trained model(s) 1006 may include any types of machine learning models depending on embodiment. In at least one embodiment, and without limitation, machine learning models used by system 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of, AI-assisted annotation included in training pipelines 1004. In at least one embodiment, system 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types), including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface (UI) 1014 (e.g., a graphical user interface, a web interface, etc.) that may be used to select applications for inclusion in deployment pipeline(s) 1010, arrange applications, modify or change applications or parameters or constructs thereof, use and intera with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904. In at least one embodiment, training system 904 and deployment system 906 may include DICOM adapters 1002A and 1002B.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 920 leveraged and shared by applications or containers in deployment system 906 may include compute services 1016, collaborative content creation services 1017, AI services 1018, simulation services 1019, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA®) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inferencing services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inferencing tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inferencing tasks of Al services 1018.

In at least one embodiment, shared storage may be mounted to AI services 1018 within system 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing or other light transport simulation techniques, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA® and/or QUADRO® GPUs) may include any number of GPUs that may be used for executing processing tasks of compute services 1016, collaborative content creation services 1017, AI services 1018, simulation services 1019, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inferencing (e.g., to execute machine learning models). In at least one embodiment, cloud 1026, AI system 1024, and/or other components of system 1000 may use GPUs 1022. In at least one embodiment, cloud 1026 may include a GPU-optimized platform for deep learning tasks. In at least one embodiment, AI system 1024 may use GPUs, and cloud 1026-or at least a portion tasked with deep learning or inferencing-may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inferencing, deep learning, machine learning, and/or other artificial intelligence tasks. In at least one embodiment, AI system 1024 (e.g., NVIDIA's DGX™) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of system 1000.

In at least one embodiment, cloud 1026 may include a GPU-accelerated infrastructure (e.g., NVIDIA's NGC™) that may provide a GPU-optimized platform for executing processing tasks of system 1000. In at least one embodiment, cloud 1026 may include an AI system(s) 1024 for performing one or more of AI-based tasks of system 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of system 1000, including compute services 1016, AI services 1018, and/or visualization services 1020, as described herein. In at least one embodiment, cloud 1026 may perform small and large batch inference (e.g., executing NVIDIA's TensorRT™), provide an accelerated parallel computing API and platform 1030 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1000.

In at least one embodiment, in an effort to preserve patient confidentiality (e.g., where patient data or records are to be used off-premises), cloud 1026 may include a registry, such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

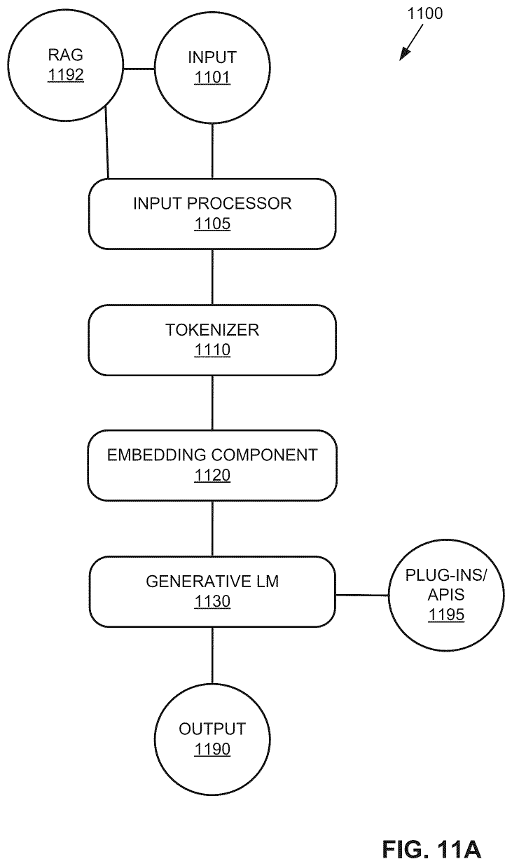

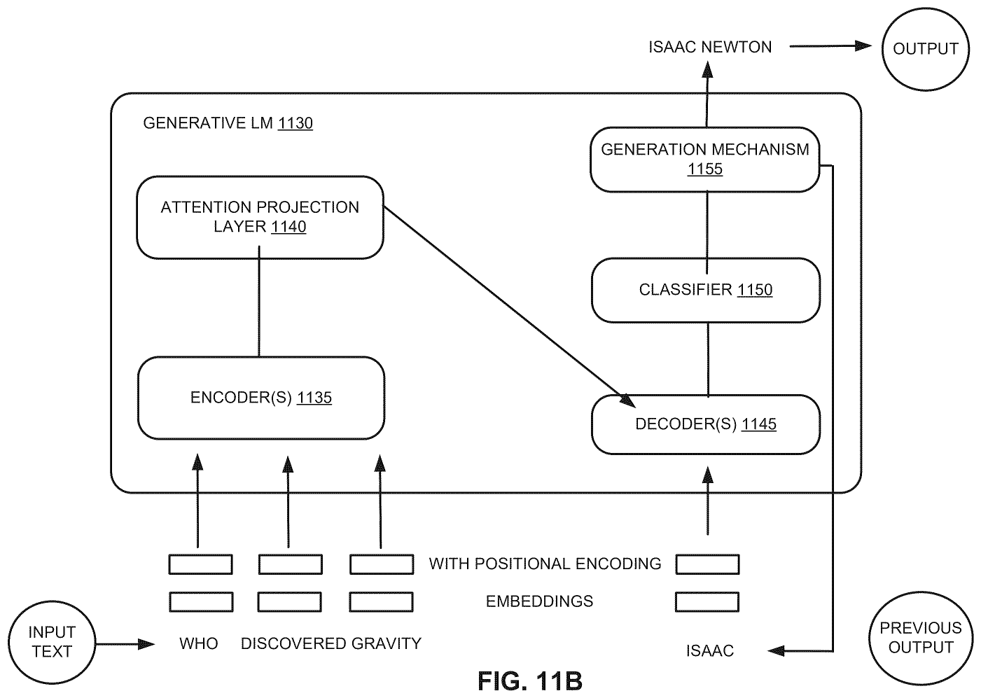

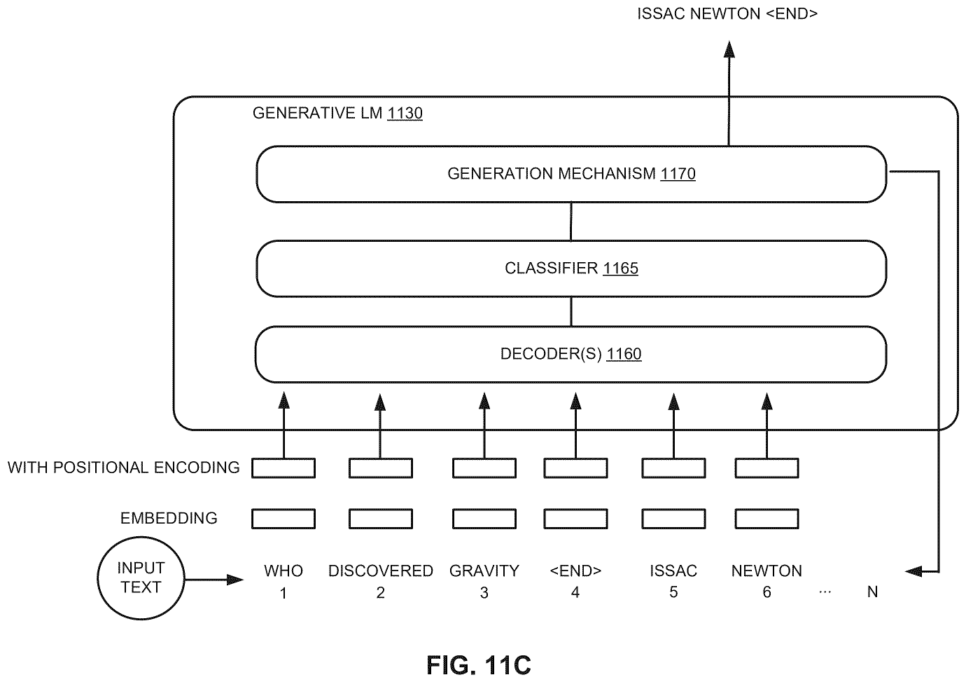

FIG. 11A is a block diagram of an example generative language model system 1100 suitable for use in implementing at least some embodiments of the present disclosure. In the example illustrated in FIG. 11A, the generative language model system 1100 includes a retrieval augmented generation (RAG) component 1192, an input processor 1105, a tokenizer 1110, an embedding component 1120, plug-ins/APIs 1195, and a generative language model (LM) 1130 (which may include an LLM, a VLM, a multi-modal LM, etc.).

At a high level, the input processor 1105 may receive an input 1101 comprising text and/or other types of input data (e.g., audio data, video data, image data, sensor data (e.g., LiDAR, RADAR, ultrasonic, etc.), 3D design data, CAD data, universal scene descriptor (USD) data, etc.), depending on the architecture of the generative LM 1130. In some embodiments, the input 1101 includes plain text in the form of one or more sentences, paragraphs, and/or documents. Additionally or alternatively, the input 1101 may include numerical sequences, precomputed embeddings (e.g., word or sentence embeddings), and/or structured data (e.g., in tabular formats, JSON, or XML). In some embodiments in which the generative LM 1130 is capable of processing multimodal inputs, the input 1101 may combine text with image data, audio data, and/or other types of input data, such as but not limited to those described herein. Taking raw input text as an example, the input processor 1105 may prepare raw input text in various ways. For example, the input processor 1105 may perform various types of text cleaning to remove noise (e.g., special characters, punctuation, HTML tags, stopwords) from relevant textual content. In an example involving stopwords (common words that tend to carry little semantic meaning), the input processor 1105 may remove stopwords to reduce noise and focus the generative LM 1130 on more meaningful content. The input processor 1105 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1192 may be used to retrieve additional information to be used as part of the input 1101 or prompt. For example, in some embodiments, the input 1101 may be generated using the query or input to the model (e.g., a question, a request, etc.) in addition to data retrieved using the RAG component 1192. In some embodiments, the input processor 1105 may analyze the input 1101 and communicate with the RAG component 1192 (or the RAG component 1192 may be part of the input processor 1105, in embodiments) in order to identify relevant text and/or other data to provide to the generative LM 1130 as additional context or sources of information from which to identify the response, answer, or output 1190, generally. For example, where the input indicates that the user is interested in a desired tire pressure for a particular make and model of vehicle, the RAG component 1192 may retrieve-using a vector search in an embedding space, for example-the tire pressure information or the text corresponding thereto from a digital (embedded) version of the user manual for that particular vehicle make and model. Similarly, where a user revisits a chatbot related to a particular product offering or service, the RAG component 1192 may retrieve a prior stored conversation history-or at least a summary thereof-and include the prior conversation history along with the current ask/request as part of the input 1101 to the generative LM 1130.

The tokenizer 1110 may segment the (e.g., processed) text into smaller units (tokens) for subsequent analysis and processing. The tokens may represent individual words, subwords, characters, etc., depending on the embodiment. Word-based tokenization divides the text into individual words, treating each word as a separate token. Subword tokenization breaks down words into smaller meaningful units (e.g., prefixes, suffixes, stems), enabling the generative LM 1130 to understand morphological variations and handle out-of-vocabulary words more effectively. Character-based tokenization represents each character as a separate token, enabling the generative LM 1130 to process text at a fine-grained level. The choice of tokenization strategy may depend on factors such as the language being processed, the task at hand, and/or characteristics of the training dataset. As such, the tokenizer 1110 may convert the (e.g., processed) text into a structured format according to tokenization schema being implemented in the particular embodiment.

The embedding component 1120 may use any known embedding technique to transform discrete tokens into (e.g., dense, continuous vector) representations of semantic meaning. For example, the embedding component 1120 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some embodiments in which the input 1101 includes image data, the input processor 1101 may resize the image data to a standard size compatible with format of a corresponding input channel and/or may normalize pixel values to a common range (e.g., 0 to 1) to ensure a consistent representation, and the embedding component 1120 may encode the image data using any known technique (e.g., using one or more convolutional neural networks (CNNs) to extract visual features). In some embodiments in which the input 1101 includes audio data, the input processor 1101 may resample an audio file to a consistent sampling rate for uniform processing, and the embedding component 1120 may use any known technique to extract and encode audio features-such as in the form of a spectrogram (e.g., a mel-spectrogram). In some embodiments in which the input 1101 includes video data, the input processor 1101 may extract frames or apply resizing to extracted frames, and the embedding component 1120 may extract features such as optical flow embeddings or video embeddings and/or may encode temporal information or sequences of frames. In some embodiments in which the input 1101 includes multimodal data, the embedding component 1120 may fuse representations of the different types of data (e.g., text, image, audio) using techniques like early fusion (concatenation), late fusion (sequential processing), attention-based fusion, etc.

The generative LM 1130 and/or other components of the generative LLM system 1100 may use different types of neural network architectures depending on the embodiment. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the embodiment and architecture, the embedding component 1120 may apply an encoded representation of the input 1101 to the generative LM 1130, and the generative LM 1130 may process the encoded representation of the input 1101 to generate an output 1190, which may include responsive text and/or other types of data.

As described herein, in some embodiments, the generative LM 1130 may be configured to access or use—or capable of accessing or using—plug-ins/APIs 1195 (which may include one or more plug-ins, application programming interfaces (APIs), databases, data stores, repositories, etc.). For example, for certain tasks or operations that the generative LM 1130 is not ideally suited for, the model may have instructions (e.g., as a result of training, and/or based on instructions in a given prompt, such as those retrieved using the RAG component 1192) to access one or more plug-ins/APIs 1195 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1195 to the plug-in/API 1195, the plug-in/API 1195 may process the information and return an answer to the generative LM 1130, and the generative LM 1130 may use the response to generate the output 1190. This process may be repeated—e.g., recursively—for any number of iterations and using any number of plug-ins/APIs 1195 until an output 1190 that addresses each ask/question/request/process/operation/etc from the input 1101 can be generated. As such, the model(s) may not only rely on its own knowledge from training on a large dataset(s) and/or from data retrieved using the RAG component 1192, but also on the expertise or optimized nature of one or more external resources—such as the plug-ins/APIs 1195.

FIG. 11B is a block diagram of an example embodiment in which the generative LM 1130 includes a transformer encoder-decoder, according to at least one embodiment. For example, assume input text such as “Who discovered gravity” is tokenized (e.g., by the tokenizer 1110 of FIG. 11A) into tokens such as words, and each token is encoded (e.g., by the embedding component 1120 of FIG. 911A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1135 of the generative LM 1130.

In an example embodiment, the encoder(s) 1135 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1140 may convert the context vector into attention vectors (keys and values) for the decoder(s) 1145.

In an example embodiment, the decoder(s) 1145 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1135, in an example transformer architecture, each token (e.g., word) flows through a separate path in the decoder(s) 1145. During a first pass, the decoder(s) 1145, a classifier 1150, and a generation mechanism 1155 may generate a first token, and the generation mechanism 1155 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1145 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example embodiment, the encoder-decoder attention layer operates similarly to the (e.g., multi-headed) self-attention in the encoder(s) 1135, except that it creates its queries from the layer below it and takes the keys and values (e.g., matrix) from the output of the encoder(s) 1135.

As such, the decoder(s) 1145 may output some decoded (e.g., vector) representation of the input being applied during a particular pass. The classifier 1150 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1155 may select or sample a word or token based on a corresponding predicted probability (e.g., select the word with the highest predicted probability) and append it to the output from a previous pass, generating each word or token sequentially. The generation mechanism 1155 may repeat the process, triggering successive decoder inputs and corresponding predictions until selecting or sampling a symbol or token that represents the end of the response, at which point, the generation mechanism 1155 may output the generated response.

FIG. 11C is a block diagram of an example embodiment in which the generative LM 1130 includes a decoder-only transformer architecture, according to at least one embodiment. For example, the decoder(s) 1160 of FIG. 11C may operate similarly as the decoder(s) 1145 of FIG. 11B except each of the decoder(s) 1160 of FIG. 11C omits the encoder-decoder self-attention layer (since there is no encoder in this embodiment). As such, the decoder(s) 1160 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1160. As with the decoder(s) 1145 of FIG. 11B, each token (e.g., word) may flow through a separate path in the decoder(s) 1160, and the decoder(s) 1160, a classifier 1165, and a generation mechanism 1170 may use auto-regression to sequentially generate one token at a time until predicting a symbol or token that represents the end of the response. The classifier 1165 and the generation mechanism 1170 may operate similarly as the classifier 1150 and the generation mechanism 1155 of FIG. 11B, with the generation mechanism 1170 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
processing, using a vision language model (VLM), an input to generate a segmentation map of a media item (MI), wherein the input comprises:
the MI comprising a plurality of pixels, and
a prompt associated with the MI;
wherein the segmentation map comprises:
identification of pixels associated with individual objects of one or more objects in the MI;
wherein the VLM comprises:
a dynamic portion having parameters that are determined in view of the media item; and
causing performance of one or more actions by at least one downstream system or application based on the identification of the pixels in the segmentation map.

2. The method of claim 1, wherein processing the input comprises:
processing, using a computer vision network, the MI to generate a plurality of media features;
processing, using a language-comprehension network, the prompt to generate a plurality of text features; and
using the plurality of media features and the plurality of text features to generate the segmentation map of the MI.

3. The method of claim 2, wherein using the plurality of media features and the plurality of text features to generate the segmentation map of the MI comprises:
jointly processing, using a cross-modality network, the plurality of media features and the plurality of text features to generate a plurality of cross-modal features; and
using the plurality of cross-modal features to generate the segmentation map of the MI.

4. The method of claim 3, wherein using the plurality of cross-modal features to generate the segmentation map of the MI comprises:
computing, using the plurality of cross-modal features, the parameters of the dynamic portion.

5. The method of claim 3, wherein using the plurality of cross-modal features to generate the segmentation map of the MI comprises:
processing, using the dynamic portion, at least the plurality of cross-modal features to generate the segmentation map of the MI.

6. The method of claim 5, wherein the dynamic portion further processes a plurality of coordinates associated with the media features.

7. The method of claim 2, wherein the plurality of media features is enhanced using an attention-based network that uses at least one of:
the plurality of media features as queries and the plurality of text features as keys and values, or
the plurality of text features as queries and the plurality of media features as keys and values.

8. The method of claim 1, wherein the one or more actions comprise at least one of:
generating a description of the MI,
tracking one or more objects depicted in the MI,
identifying a type of a scene depicted in the MI,
identifying a type of an action depicted in the MI,
controlling an autonomous vehicle,
modifying operations of a manufacturing control system,
controlling a security system,
generating an automated medical diagnostic determination, or
generating an automated patient wellbeing alarm.

9. The method of claim 1, wherein the prompt comprises a natural language prompt, and wherein the MI comprises at least one of:
an image item,
a video item,
an audio item, or
sensor data item.

10. The method of claim 1, further comprising:
generating, using the VLM, at least one of:
bounding shapes for the one or more objects in the MI, or
classification of the one or more objects in the MI.

11. The method of claim 1, wherein the VLM is trained using a training data comprising:
a training input comprising:
a training MI,
a training prompt associated with the training MI, and
a ground truth segmentation mask associated with the training MI.

12. The method of claim 11, wherein the ground truth segmentation mask is generated by a machine learning model that processes an input comprising a cropped portion depicting an object in the training MI and identifies a foreground of the cropped portion.

13. A system comprising:
one or more processing units to:
process, using a vision language model (VLM), an input to generate a segmentation map of a media item (MI), wherein the input comprises:
the MI comprising a plurality of pixels, and
a prompt associated with the MI;
wherein the segmentation map comprises:
identification of pixels associated with individual objects of one or more objects in the MI;
wherein the VLM comprises:
a dynamic portion having parameters that are determined in view of the media item; and
cause performance of one or more actions by at least one downstream system or application based on the identification of the pixels in the segmentation map.

14. The system of claim 13, wherein to process the input, the one or more processing units are to:
process, using a computer vision network, the MI to generate a plurality of media features;
process, using a language-comprehension network, the prompt to generate a plurality of text features; and
generate, using the plurality of media features and the plurality of text features, the segmentation map of the MI.

15. The system of claim 14, wherein to generate the segmentation map of the MI, the one or more processing units are to:
jointly process, using a cross-modality network, the plurality of media features and the plurality of text features to generate a plurality of cross-modal features; and
use the plurality of cross-modal features to generate the segmentation map of the MI.

16. The system of claim 15, wherein to use the plurality of cross-modal features to generate the segmentation map of the MI, the one or more processing units are to:
compute, using the plurality of cross-modal features, the parameters of the dynamic portion.

17. The system of claim 15, wherein to use the plurality of cross-modal features to generate the segmentation map of the MI, the one or more processing units are to:
process, using the dynamic portion, at least the plurality of cross-modal features to generate the segmentation map of the MI.

18. The system of claim 17, wherein the dynamic portion further processes a plurality of coordinates associated with the media features.

19. The system of claim 13, wherein the system is comprised in at least one of:
an in-vehicle infotainment system for an autonomous or semi-autonomous machine;
a system for performing one or more simulation operations;
a system for performing one or more digital twin operations;
a system for performing one or more medical operations;
a system for performing one or more factory operations;
a system for performing one or more analytics operations;
a system for performing light transport simulation;
a system for performing collaborative content creation for 3D assets;
a system for performing one or more deep learning operations;
a system implemented using an edge device;
a system for generating or presenting at least one of virtual reality content, mixed reality content, or augmented reality content;
a system implemented using a robot;
a system for performing one or more conversational AI operations;
a system implementing one or more large language models (LLMs);
a system implementing one or more vision language models (VLMs);
a system implementing one or more language models;
a system for performing one or more generative AI operations;
a system for generating synthetic data;
a system incorporating one or more virtual machines (VMs);
a system implemented at least partially in a data center; or
a system implemented at least partially using cloud computing resources.

20. A non-transitory computer-readable memory storing instructions thereon that, when executed by a processing device, cause the processing device to:
process, using a vision language model (VLM), an input to generate a segmentation map of a media item (MI), wherein the input comprises:
the MI comprising a plurality of pixels, and
a prompt associated with the MI;
wherein the segmentation map comprises:
identification of pixels associated with individual objects of one or more objects in the MI;
wherein the VLM comprises:
a dynamic portion having parameters that are determined in view of the media item; and
cause performance of one or more actions by at least one downstream system or application based on the identification of the pixels in the segmentation map.
